(19) United States
(12) Patent Application Publication
(10) Pub. No.: US 2024/0383462 A1
(43) Pub. Date: Nov. 21, 2024

(54) BRAKE APPARATUS AND CONTROLLING METHOD THEREOF

(71) Applicant: HL MANDO CORPORATION, Gyeonggi-do (KR)

(72) Inventor: Hanjun LEE, Gyeonggi-do (KR)

(21) Appl. No.: 18/387,752

(22) Filed: Nov. 7, 2023

(30) Foreign Application Priority Data
May 16, 2023 (KR) 10-2023-0062904

(51) Int. Cl. B60T 17/22; B60T 13/68

(52) U.S. Cl. CPC B60T 17/22; B60T 13/68; B60T 2270/406

(57) ABSTRACT

A solenoid valve state diagnostic method may include monitoring a voltage value of an induced voltage generated at both ends of a coil of a solenoid valve, determining a state of a plunger of the solenoid valve as a normal state or an abnormal state based on a comparison of the voltage value of the induced voltage and a pre-stored voltage value of a normal induced voltage and outputting information based on the determination.

### CROSS-REFERENCE TO RELATED APPLICATION

This application is based on and claims priority under 35 U.S.C. § 119 to Korean Patent Application No. 10-2023-0062904, filed on May 16, 2023, in the Korean Intellectual Property Office, the disclosure of which is incorporated herein by reference herein in its entirety.

### BACKGROUND

### 1. Field

Embodiments of the present disclosure relate to a brake apparatus and a controlling method thereof.

### 2. Description of the Related Art

A vehicle's brake system, such as an Integrated Dynamic Brake (IDB) system, can control the vehicle's braking through a flow control method using a solenoid valve. The solenoid valve is a structure that combines a coil and a valve portion. The coil is directly connected to an Electronic Control Unit (ECU), and the coil's magnetic flux induces firing of the core and plunger in the valve portion installed inside the coil, controlling the on and/or off of the valve.

On the other hand, the braking performance of the brake system is very sensitive to the operation of the valve portion in the solenoid valve, making the diagnosis of failures in the valve portion of the solenoid valve very important.

However, it is difficult to receive feedback on the diagnosis of the valve portion's status because it is electrically insulated from the electronic control device (also called a control circuit) in the solenoid valve of the brake system.

In reality, the conventional approach to diagnosing the status of the solenoid valve has been limited to the coil, which is the portion of the solenoid valve.

For example, in the prior art, fault diagnosis of the solenoid valve was carried out by identifying the openness and short-circuit of the coil in the solenoid valve through voltage identification of the control circuit or by identifying the current tracking according to the provision of the control signal corresponding to the target current in the control circuit.

However, when problems such as foreign matter influx into the plunger included in the valve portion of the solenoid valve or performance degradation of the plunger occur, issues may arise in the operation of the valve portion in the solenoid valve. However, because a normal level of current flows in the coil, the electronic control device directly connected to the coil cannot detect this problem.

As a result, for the enhancement of the safety of the brake system, there is a demand for the development of a technology that can diagnose the state of the valve portion, particularly the plunger, in the solenoid valve.

### SUMMARY

Therefore, it is an aspect of the present disclosure to provide a method and device for diagnosing a state of a plunger in a solenoid valve, to enhance the safety of the brake system.

In accordance with one aspect of the present disclosure, a method of controlling a brake apparatus may include monitoring a voltage value of an induced voltage generated at both ends of a coil of a solenoid valve, determining a state of a plunger of the solenoid valve as a normal state or an abnormal state based on a comparison of the voltage value of the induced voltage and a pre-stored voltage value of a normal induced voltage and outputting information based on the determination.

The monitoring of the voltage value of the induced voltage generated at both ends of the coil of the solenoid valve, may include determining a difference value between the voltage between the drain and source of the field effect transistor connected to the first end of the coil for driving the solenoid valve, and the voltage applied to the second end of the coil as the voltage value of the induced voltage.

The induced voltage may be generated immediately after turning on or off the solenoid valve.

The voltage value of the pre-stored normal induced voltage may include a voltage value of a normal induced voltage that changes over time during a period of time.

The determining of the state of the plunger of the solenoid valve as the normal state or the abnormal state, may include determining the normal state of the plunger when a difference between the induced voltage and the pre-stored normal induced voltage is within a predetermined reference error range.

The determining of the state of the plunger of the solenoid valve as the normal state or the abnormal state, may include determining the abnormal state of the plunger when the difference between the induced voltage and the pre-stored normal induced voltage is not within the predetermined reference error range.

The abnormal state of the plunger may include at least one of a state of foreign matter influx into the plunger or a state of restricted movement of the plunger.

In accordance with one aspect of the present disclosure, a method of determining a state of a solenoid valve of a brake apparatus may include monitoring a voltage between a drain and a source of a field effect transistor for driving a solenoid valve, determining, based on the voltage between the drain and source of the field effect transistor, a state of a plunger of the solenoid valve as a normal state or an abnormal state and outputting information based on the determination.

The determining of the state of the plunger of the solenoid valve as the normal state or the abnormal state, may include monitoring, based on the voltage between the drain and source of the field effect transistor, a voltage value of an induced voltage generated at both ends of a coil of the solenoid valve; and determining the state of the plunger of the solenoid valve as the normal state or the abnormal state based on a comparison of the voltage value of the induced voltage and a pre-stored voltage value of a normal induced voltage.

The field effect transistor is connected to the first end of the coil. Further, the voltage value of the induced voltage of the coil may include a difference value of the voltage between the drain and source and the voltage applied to the second end of the coil.

The voltage value of the pre-stored normal induced voltage may include a voltage value of a normal induced voltage that changes over time during a predetermined time interval.

The determining of the state of the plunger of the solenoid valve as the normal state or the abnormal state, may include determining the normal state of the plunger when a difference between the induced voltage and the pre-stored normal induced voltage is within a predetermined reference error range.

The determining of the state of the plunger of the solenoid valve as the normal state or the abnormal state, may include determining the abnormal state of the plunger when the difference between the induced voltage and the pre-stored normal induced voltage is not within the predetermined reference error range.

The abnormal state of the plunger may include at least one of a state of foreign matter influx into the plunger or a state of restricted movement of the plunger.

In accordance with one aspect of the present disclosure, a brake apparatus may include a solenoid valve including a coil and a plunger installed inside the coil so as to be able to slide in and out, a drive circuit configured to drive the solenoid valve, a memory configured to store a voltage value of a normal induced voltage and a controller electrically connected to the coil of the solenoid valve. Further, the controller may monitor a voltage value of the induced voltage generated at both ends of the coil, and determine a state of the plunger as a normal state or an abnormal state based on the comparison of the voltage value of the induced voltage and the voltage value of the normal induced voltage stored in the memory, and output information based on the determination.

The drive circuit may include a field effect transistor connected to the first end of the coil. Further, the controller may determine a difference value between the voltage between the drain and source of the field effect transistor and the voltage applied to the second end of the coil as the voltage value of the induced voltage.

The controller may identify the voltage between the drain and source of the field effect transistor, when the amount of change in the voltage between the drain and source, which is generated immediately after turning on or off of the solenoid valve, is more than a predetermined threshold change.

The voltage value of the normal induced voltage may include a voltage value of a normal induced voltage that changes over time during a period of time.

The controller may determine the normal state of the plunger when a difference between the induced voltage and the pre-stored normal induced voltage is within a predetermined reference error range, and determine the abnormal state of the plunger when the difference between the induced voltage and the pre-stored normal induced voltage is within the predetermined reference error range.

The abnormal state of the plunger may include at least one of a state of foreign matter influx into the plunger or a state of restricted movement of the plunger.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram including some configurations of a brake apparatus according to one embodiment;

FIG. 2 is a view illustrating a structure of a solenoid valve according to one embodiment;

FIG. 3 is a flow diagram illustrating an operation of a brake system 1 (and/or a controller 100) according to one embodiment;

FIG. 4 is a flow diagram illustrating an operation of a brake system 1 (and/or a controller 100) according to one embodiment;

FIG. 5 is a view illustrating a test board including a solenoid valve fabricated to derive the present disclosure and a circuit configuration connected to each coil of the solenoid valve;

FIG. 6 is a view illustrating some configurations of a test board including a solenoid valve fabricated to derive the present disclosure;

FIGS. 7A and 7B are a graph illustrating the voltage measured on one side and the other side of a coil for each condition of air gap on a test board; and

FIG. 8 is a graph illustrating the change in reluctance between the first and second case.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

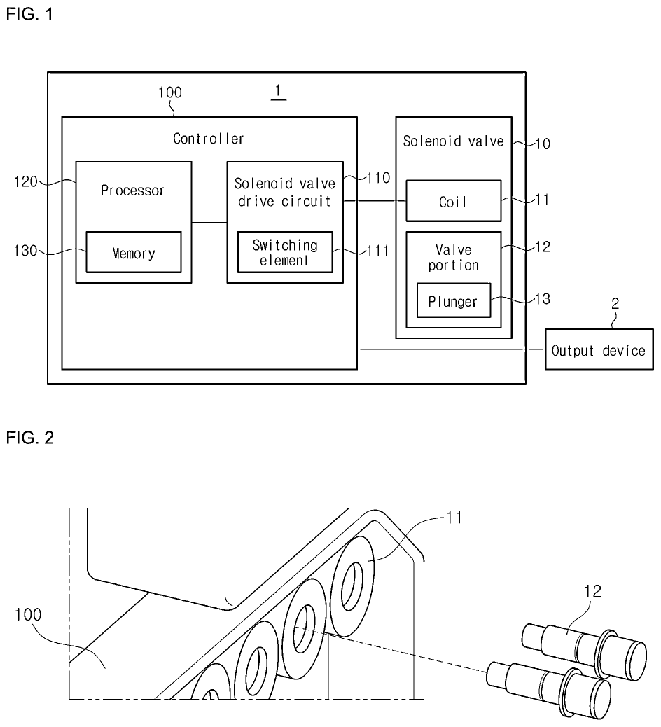

FIG. 1 is a block diagram including some configurations of a brake system according to one embodiment. FIG. 2 is a view illustrating a structure of a solenoid valve according to one embodiment.

Referring to FIG. 1, brake system 1 may include a solenoid valve 10 and a controller 100.

Referring to FIGS. 1 and 2, the solenoid valve 10 may include one or more coils 11 and a valve portion 12 installed in each of the one or more coils 11.

The coils 11 may be electrically connected to the controller 100 to generate magnetic flux.

The configuration of the respective connections at one end and the other end of the coils 11 may be any circuit configuration of a conventional solenoid valve.

For example, one end of the coil 11 may be connected to a power supply (not shown), and the other end of the coil 11 may be connected to a drain end D of a field effect transistor (FET) 111, a switching element described later.

For example, when power is applied to the coil 11, a magnetic field is formed around the coil 11 by the current flowing in the coil 11.

The valve portion 12 may be installed on the inner side of the coil 11, and the configuration of the valve portion of a conventional solenoid valve may be applied.

The valve portion 12 may include a plunger 13 slidably retractable installed on the inner side of the coil 11.

Depending on the sliding retraction motion of the plunger 13, a flow passage formed in the valve portion 12 may be opened or closed.

For example, the plunger 13 may close the flow passage (not shown) formed in the valve portion 12 in response to a magnetic field formed around the coil 11, and may allow the flow passage to open in the absence of a magnetic field formed around the coil 11.

Although not shown, the valve portion 12 may include any configuration of a valve portion of a conventional solenoid valve.

For example, although not shown, the valve portion 12 may include a core (not shown) in which a flow passage (not shown) is formed, a longitudinal through-hole (not shown) formed in the center, and an orifice (not shown) provided at the top of the through-hole (not shown) for opening and closing the flow passage (not shown).

Also, although not shown, the valve portion 12 may include an armature (not shown) that is slidably retractable installed on one side of the core (not shown) to open and close the orifice (not shown).

Additionally, although not shown, the valve portion 12 may include a spring (not shown) disposed at one end of the plunger 13 to retract the plunger 13 and the armature (not shown) to open the opening of the core (not shown) when power is not applied to the coil 11.

For example, when power is applied to the coil 11, a magnetic field may be formed around the coil 11 by the current flowing in the coil 11. This magnetic field may cause the armature (not shown) to advance towards the core (not shown), and the advancement of the armature (not shown) may cause the plunger 13 to advance and close the flow passage (not shown).

On the other hand, when power is not applied to the coil 11, no magnetic field is generated, and accordingly, the elasticity of the spring (not shown) may cause the plunger 13 and the armature (not shown) to retract, opening the flow passage (not shown).

The controller 100 (also referred to as an electronic control unit (ECU)) may be electrically connected to the coil 11 of the solenoid valve 10.

The controller 100 may include a solenoid valve drive circuit 110 and/or a processor 120.

The solenoid valve drive circuit 110 may be electrically connected with the coil 11 of the solenoid valve 10 to drive the solenoid valve 10.

The solenoid valve drive circuit 110 may include a switching element 111, such as a FET 111. Hereinafter, the switching element 111 may be referred to as the FET 111.

The processor 120 may include a memory 130 that stores or remembers programs and data for implementing operations to control the configurations included in the brake system 1.

The memory 130 may provide stored programs and data to the processor 120 and may remember temporary data that is generated during operation of the processor 120. For example, the memory 130 may include volatile memory, such as static random access memory (S-RAM), dynamic random access memory (D-RAM), and non-volatile memory, such as read only memory (ROM), erasable programmable read only memory (EPROM), electrically erasable programmable read only memory (EEPROM), and flash memory.

The memory 130 may store voltage value (also referred to as voltage level) of a normal induced voltage.

The voltage value of the normal induced voltage can include voltage value of the normal induced voltage that changes over time during a period of time.

For example, the voltage value of the normal induced voltage stored in the memory 130 may be a voltage value of the normal induced voltage obtained through a previous test.

Further, the voltage value of the normal induced voltage stored in the memory 130 may be a voltage value of the induced voltage determined by the controller 100 when the state of the plunger is determined by the controller 100 to be in a normal state, according to an embodiment of the present disclosure.

The controller 100 may control the supply or cut-off of power from the power supply device (not shown) to the coil 11 of the solenoid valve 10.

The controller 100 may control the solenoid valve drive circuit 110 to control the driving of the solenoid valve 10.

The controller 100 may monitor (also referred to as identify) the voltage at both ends of the coil 11.

For example, the controller 100 may monitor (or identify) a voltage applied to one end of the coil 11, and may monitor (or identify) a voltage between the drain end D and the source end D of the FET 111 connected to the other end of the coil 11.

The controller 100 may determine a voltage value of the induced voltage generated at both ends of the coil 11 of the solenoid valve 10.

Based on the comparison of the voltage value of the induced voltage and the pre-stored voltage value of a normal induced voltage, the controller 100 may determine the state of the plunger 13 of the solenoid valve 10 as a normal state or an abnormal state.

The controller 100 may provide information based on the determination of the state of the plunger 13 to an external output device 2 via CAN communication or the like. For example, the controller 100 may include a communication circuit (not shown) for CAN communication.

For example, the output device 2 may include a display device and/or a speaker or the like of a vehicle in which the brake system 1 is installed, and the output device 2 may output the information provided so that it can be viewed by a user of the vehicle.

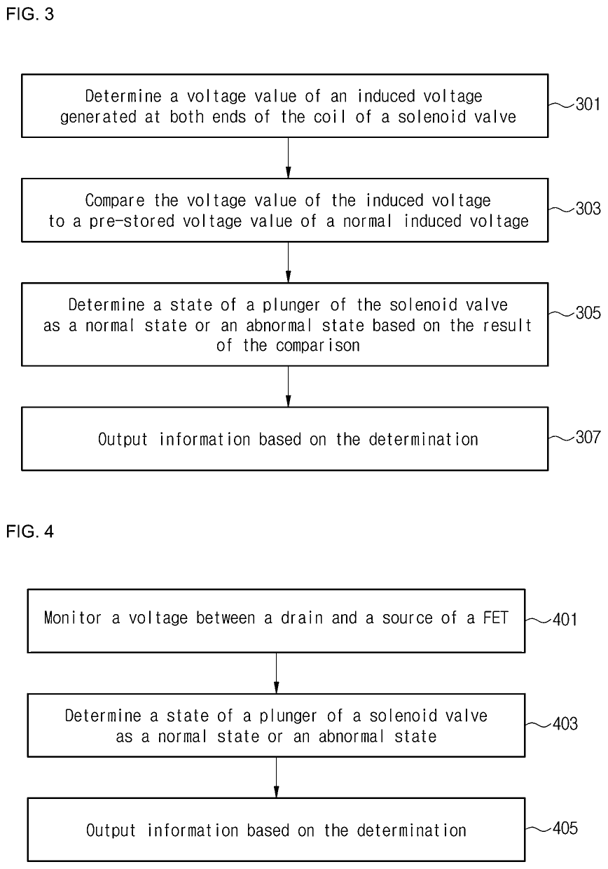

FIG. 3 is a flow diagram illustrating an operation of a brake system 1 (and/or a controller 100) according to one embodiment.

Referring to FIG. 3, the brake system 1 may determine a voltage value of the induced voltage generated at both ends of the coil 11 of the solenoid valve 10 (301).

The brake system 1 may determine the voltage value of the induced voltage as a difference value between the voltage between the drain and source of the FET 111 electrically connected to the first end of the coil 11 and the voltage applied to the second end of the coil 11.

The induced voltage may be generated immediately after the solenoid valve 10 is turned on or off.

Accordingly, the brake system 1 may determine a difference value between the voltage between the drain and source of the FET 111 and the voltage applied to the coil 11 during a predetermined time interval immediately after the on or off of the solenoid valve 10 as the voltage value of the induced voltage.

The brake system 1 may compare the voltage value of the induced voltage to a pre-stored voltage value of a normal induced voltage (303).

The pre-stored voltage value of the normal induced voltage may include a voltage value of the normal induced voltage that changes over time during a predetermined time interval (also referred to as a period of time).

The brake system 1 may determine a state of the plunger 13 of the solenoid valve 10 as a normal state or an abnormal state based on the result of the comparison of operation 303 (305).

The brake system 1 may determine the state of the plunger 13 as the normal state when a difference between the induced voltage and the pre-stored normal induced voltage is within a predetermined reference error range.

The brake system 1 may determine the state of the plunger 13 as the abnormal state when the difference between the induced voltage and the pre-stored normal induced voltage is not within the predetermined reference error range.

For example, the abnormal state of the plunger 13 may include a state of foreign matter influx into the plunger 13 and/or a state of restricted movement of the plunger 13.

The brake system 1 may output information based on the determination at operation 305 (307).

For example, the brake system 1 may provide information based on the determination, such as information that the plunger 13 is in the normal state or the abnormal state, to an external output device 2 connected to the brake system 1.

FIG. 4 is a flow diagram illustrating an operation of the brake system 1 (and/or controller 100) according to one embodiment.

Referring to FIG. 4, the brake system 1 may monitor a voltage between a drain and a source of the FET 111 for driving the solenoid valve 10 (401).

Based on the voltage between the drain and source of the FET 111, the brake system 1 may determine a state of the plunger 13 of the solenoid valve 10 as a normal or an abnormal state (403).

Based on the voltage between the drain and source of the FET 111, the brake system 1 may determine a voltage value of the induced voltage generated at both ends of the coil 11 of the solenoid valve 10.

For example, the determination of the voltage value of the induced voltage may be performed in the same manner as the voltage value determination method of the induced voltage of the embodiment of FIG. 3 described above.

The brake system 1 may determine a state of the plunger 13 as the normal state or the abnormal state based on a comparison of the determined voltage value of the induced voltage and a pre-stored voltage value of the normal induced voltage.

For example, determination the state of the plunger 13 as the normal state or the abnormal state may be performed in the same manner as determination the state of the plunger 13 as the normal state or the abnormal state in the embodiment of FIG. 3.

The brake system 1 may output information based on the determination of the operation 403 (405).

For example, outputting information according to the determination of the operation 403 may be performed in the same manner as the information output method of the embodiment of FIG. 3.

In addition to the above-described embodiment, the brake system 1 may further perform a conventional state diagnosis method for a coil of a solenoid valve. Accordingly, a more reliable solenoid valve state diagnosis method can be provided compared to the conventional solenoid valve state diagnosis method.

The above-described embodiments can be said to be derived from the following tests.

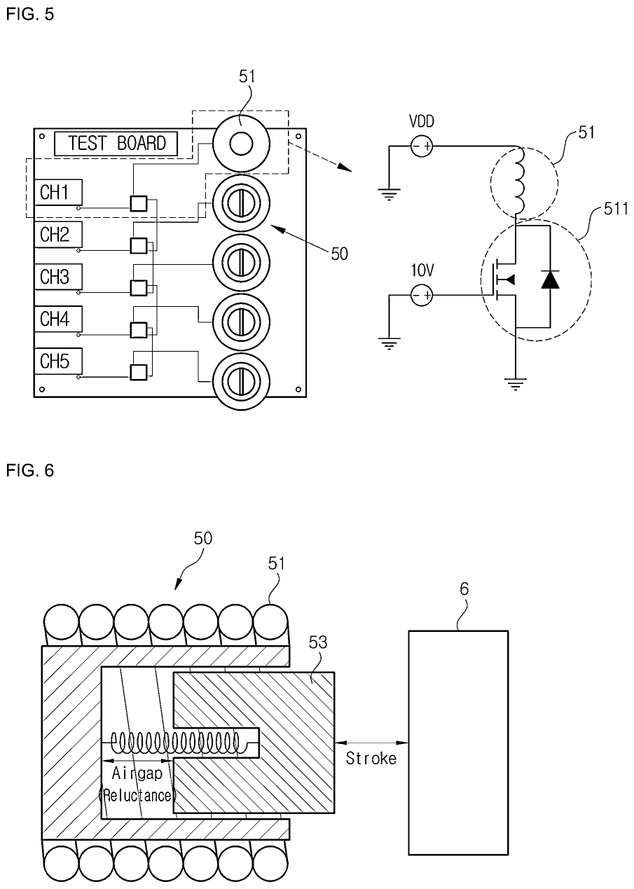

FIG. 5 is a view illustrating a test board including a solenoid valve fabricated to derive the present disclosure, and a circuit configuration connected to each coil of the solenoid valve.

Referring to FIG. 5, the test board consists of a total of five channels (CH1, CH2, CH3, CH4, CH5) to improve data reliability, with a constant voltage (VDD) applied to one side of the coil 51 of each solenoid valve 50, and an FET 511 connected to the other side of the coil 51 enabling on and/or off control of the FET 511.

During the test, a voltage of 10V was applied to the gate of the FET 511 to operate the FET 511 in the saturation region, and a power supply with low linearity was applied to increase the sharpness of the electromotive force (EMF) of the FET 511 when the FET 511 is turned on and/or off, thereby speeding up the time evolution of the induced voltage generation.

In addition, the coil 51 with the characteristics shown in the following Table 1 was applied.

TABLE 1

| Inductance | Resistance | Rated current |
|---|---|---|
| 14.7 mH | 18.3Ω | 700 mA(@14 V) |

An obstacle acting as a damper was installed in the direction of the movement of the plunger, as shown in FIG. 6, to generate a difference in voltage output according to the normal and abnormal state of the plunger of the solenoid valve 50 on the test board,

FIG. 6 is a view illustrating some configurations of a test board including a solenoid valve fabricated to derive the present disclosure.

Referring to FIG. 6, depending on the installation position of the obstacle 6 acting as a damper, the movable stroke of the plunger 53 is limited, causing a change in the air gap between the plunger 53 and the housing of the solenoid valve 50, causing a change in the reluctance as well.

Therefore, the stroke was constrained under different conditions to obtain data.

First, to check the EMF level, the voltage at both ends of the coil 51 (VDD) and the voltage between the drain and source of the FET 511 (VDS) were measured. Also, the voltage between the gate and source of the FET 511 (VGS) was measured to determine the amount of unit time change in the EMF. In addition, the current flowing in coil 51 was monitored for reluctance estimation and mathematical expression verification.

Validation was performed to verify the test board and its normal output of voltage and current.

In the normal state where the stroke is not limited, the solenoid valve 50 was turned on and/or off to measure the induced voltage generated at both ends of the coil 51, and the measured value was compared with the value calculated by the formula to verify the agreement between the measured value and the value calculated by the formula.

The actual measured values at the normal state are shown in Table 2 below.

TABLE 2

| dt(FET(50) | di(Current flowing | e(Induced voltage at both |
|---|---|---|
| Off time) | in the coil 51) | ends of the coil 51) |
| 300 us | 660 mA | 33 V(Vds-Vdd) |

As a result of substituting Inductance in Table 1 and dt and di in Table 2 into Mathematical Expression 1, the calculated theoretical value is approximately 32 [V], which is similar to the actual measured value (33V) within the error range (5%).

$$e = L \frac{di}{dt} \qquad [ Mathematical Expression 1 ]$$

(e: Induced voltage at both ends of coil 51, L: Inductance of coil 51, dt: Off time of FET 50, di: Current flowing in coil 51)

This confirms that there is no problem with the configuration of this test.

To compare the normal and abnormal states of the plunger 53, the distance between the obstacle 6 acting as a damper and the plunger 53 was adjusted to 50% of the normal distance and 99% of the normal distance (corresponding to full restraint).

In other words, actual data were obtained for each of the three cases, the first case in which the distance between the obstacle 6 and the plunger 53 was a predetermined normal distance, the second case in which the distance between the obstacle 6 and the plunger 53 was adjusted to 50% of the normal distance, and the third case in which the distance between the obstacle 6 and the plunger 53 was adjusted to 99% of the normal distance.

The equation for the relationship between the reluctance and the induced voltage in the present disclosure can be expressed as the following Mathematical Expression 2.

$$ℛ = \frac{mmf}{d ϕ} = \frac{Ndi}{ϕ} = \frac{{N}^{2} \cdot di}{edt} {\vert}_{N , di = constant} \qquad [ Mathematical Expression 2 ]$$

(R: Reluctance, mmf: Magneto-motive force, N: Number of turns of the coil, i: Current flowing in the coil, Ø: Magnetic flux, e: Induced voltage of the coil, d: amount of change)

The air gap and the induced voltage are inversely proportional to each other, and the level of the induced voltage should be the highest in the first case.

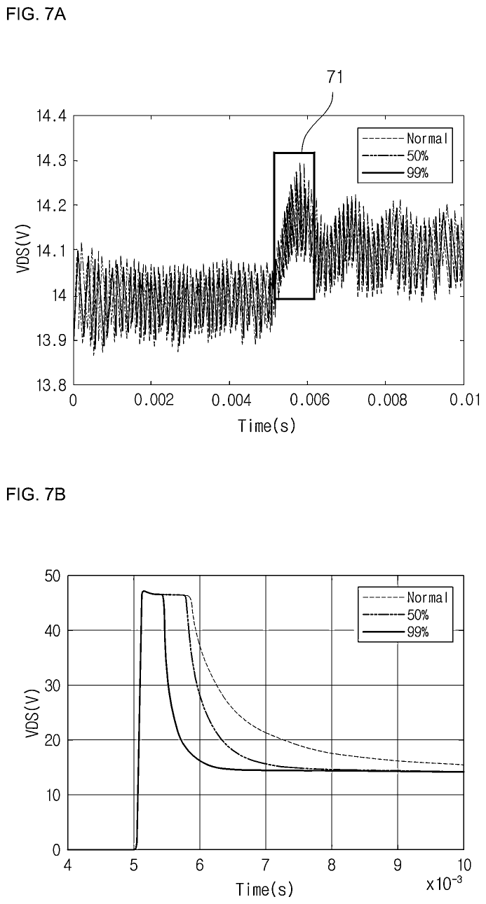

FIGS. 7A and 7B are a graph illustrating the voltage measured on one side and the other side of a coil for each condition of air gap on the test board.

Referring to FIG. 7A, the voltage measurement at one end of the VDD corresponding to the first side of the coil where VDD is supplied confirms that the induced voltage level 71 is large in the order of decreasing air gap, i.e., the third case (99%), the second case (55%), and the first case (Normal).

However, since the one end of the VDD is connected in series to the power supply, and the DC voltage is robust, it can be seen that the difference between the induced voltage levels 71 of each case is very small, and it is not possible to distinguish between each case.

On the other hand, referring to FIG. 7B, it can be seen that when the voltage of the other end of the VDS corresponding to the other side of the coil connected to the FET 511 is measured, the voltage value (or voltage level) of the induced voltage in each case is clearly distinguished compared to the measurement result of the VDD stage in FIG. 7A.

Referring to FIG. 7B, it can be seen that there is an interval in the delay time of the induced voltage in each case. Since Faraday's law dictates that induced voltage is generated at both ends of the coil 51 only while the plunger 53 is in linear motion inside the coil 51, it is possible to verify characteristics according to the air gap.

Referring to FIG. 7B, it can be seen that the area of the induced voltage over time is different in each case, which is due to the difference in reluctance, according to the following Mathematica Expression 3.

$$e \cdot dt = ( Vds - Vdd ) \cdot dt ∝ \frac{1}{d ℛ} \qquad [ Mathematical Expression 3 ]$$

(e: induced voltage, dt: amount of time change, Vds: voltage between drain and source of FET 511, Vdd: voltage supplied to coil 51)

Furthermore, by referring to the following Mathematical Expression 4, which is derived from Mathematical Expression 3, it is possible to define the correlation of the induced voltage with the current and reluctance.

$${dW}_{e} = e \cdot i \cdot dt = id λ \qquad [ Mathematical Expression 4 ]$$

$$∴ ( Vds - Vdd ) \cdot dt = d λ$$

(dWe: electrical energy change, e: induced voltage, i: current flowing in coil 51, dt: amount of time change, Vds: voltage between drain and source ends of FET 511, Vdd: voltage supplied to coil 51)

According to Mathematical Expression 4, the amount of change in current is the same for all cases, and Vdd is also the same for all cases.

Accordingly, the following Mathematical Expression 5 can be derived from Mathematical Expression 4, and from Mathematical Expression 5, it can be seen that it is possible to estimate the change in reluctance from the normal state (e.g., the first case) to the abnormal state (e.g., the second case or the third case), so that it is possible to determine whether the valve is normal or not.

$$e \cdot dt = ( {Vdd}_{1} - {Vdd}_{2} ) \cdot dt = \frac{di ( d {ℛ}_{2} - d {ℛ}_{1} )}{d {ℛ}_{1} d {ℛ}_{2}} \qquad [ Mathematical Expression 5 ]$$

(e: induced voltage, Vdd1: Vdd of the first case, Vdd2: Vdd of the second case (or third case), i: current flowing in the coil, R2: reluctance of the second case (or third case), R1: reluctance of the first case, t: time, d: amount of change)

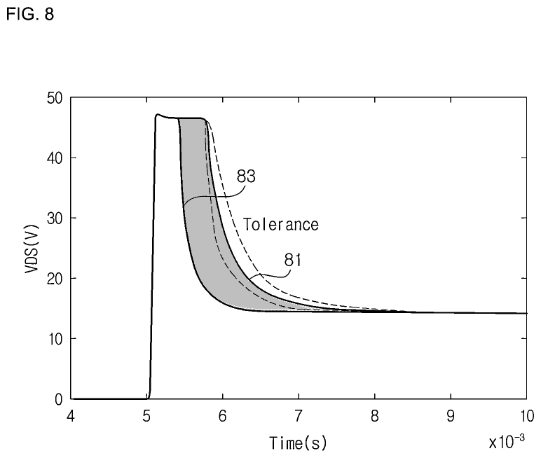

By applying the actual measured data to Mathematical Expression 4 and comparing the first and second cases, the graph shown in FIG. 8 can be obtained.

FIG. 8 is a graph showing the difference in induced voltage due to the change in reluctance between the first case and the second case.

Referring to FIG. 8, the amount of change in reluctance can be determined by the area between the voltage between the drain and source ends of the FET 511 measured in the first case (VDS 81) and the voltage between the drain and source ends of the FET 511 measured in the second case (VDS 83).

Substituting the measured normal state reluctance change by VDD voltage into Mathematical Expression 5, the reluctance of the second case can be estimated.

However, since changes in the permeability or inductance of the plunger 53 may be caused by the external environment, it is necessary to expand the criteria for the normal range to account for the error of these variables.

According to these tests, it has been concluded that, as in the above-described embodiment of the present disclosure, monitoring of the voltage between the drain and source of the FET 111 controlling the solenoid valve 10 can identify an abnormality of the plunger 13 relative to its normal state.

Furthermore, as in the above-described embodiment of the present disclosure, it has been concluded that it is possible to determine the presence or absence of an abnormality of each solenoid valve by monitoring the real-time voltage at both ends of each solenoid valve and comparing it with the normal voltage condition after storing the previously measured back data of the normal state in the memory 130.

More specifically, based on the tests described above, the brake system 1 of an embodiment of the present disclosure may store in the memory 130 a voltage value of a normal induced voltage that changes over time during a predetermined time interval. Furthermore, the brake system 1 can determine the voltage value of the induced voltage of each solenoid valve 10 by monitoring the voltage of each solenoid valve 10 in real time, and then determine whether the state of each solenoid valve 10, that is, the plunger 13 of each solenoid valve 10, is a normal state or an abnormal state by comparing the voltage value of the normal induced voltage stored in the memory 130 with the voltage value of the induced voltage of each solenoid valve 10.

Furthermore, when the above-described embodiment of the present disclosure is merged with a conventional state diagnosis technique for the coil of a solenoid valve, reliability can be further improved compared to the conventional state diagnosis technique for the solenoid valve.

The solenoid valve state diagnostic method and apparatus according to one aspect of the present disclosure can improve the safety of the brake system by diagnosing the state of the plunger in the solenoid valve.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A method of controlling a brake apparatus, the method comprising:
monitoring an induced voltage generated at first and second ends of a coil of a solenoid valve;
determining whether a state of a plunger of the solenoid valve is a normal state or an abnormal state based on a comparison of the induced voltage, generated at the first and second ends of the coil of the solenoid valve, and one or more pre-stored normal induced voltage values; and
outputting information based on the determining of whether the state of the plunger of the solenoid valve is the normal state or the abnormal state.

2. The method of claim 1, wherein the monitoring of the induced voltage generated at the first and second ends of the coil of the solenoid valve includes determining a difference between a voltage between a drain and a source of a field effect transistor connected to the first end of the coil for driving the solenoid valve and a voltage applied to the second end of the coil.

3. The method of claim 1, wherein the monitoring of the induced voltage generated at the first and second ends of the coil of the solenoid valve comprises monitoring the induced voltage which is generated immediately after turning on or off the solenoid valve.

4. The method of claim 1, wherein the one or more pre-stored normal induced voltage values include a voltage value of a normal induced voltage that changes over time during a predetermined period of time.

5. The method of claim 1, wherein the determining of whether the state of the plunger of the solenoid valve is the normal state or the abnormal state includes determining that the state of the plunger of the solenoid valve is the normal state when a difference between the induced voltage, generated at the first and second ends of the coil of the solenoid valve, and the one or more pre-stored normal induced voltage values is within a predetermined reference error range.

6. The method of claim 1, wherein the determining of whether the state of the plunger of the solenoid valve is the normal state or the abnormal state includes determining that the state of the plunger of the solenoid valve is the abnormal state when a difference between the induced voltage, generated at the first and second ends of the coil of the solenoid valve, and the one or more pre-stored normal induced voltage values is out of a predetermined reference error range.

7. The method of claim 1, wherein the abnormal state of the plunger of the solenoid valve includes at least one of a state of an influx of foreign matter into the plunger or a state of restricted movement of the plunger.

8. A method of controlling a brake apparatus, the method comprising:
monitoring a voltage between a drain and a source of a field effect transistor for driving a solenoid valve;
determining whether a state of a plunger of the solenoid valve is a normal state or an abnormal state based on the voltage between the drain and the source of the field effect transistor; and
outputting information based on the determining of whether the state of the plunger of the solenoid valve is the normal state or the abnormal state.

9. The method of claim 8, wherein the determining of whether the state of the plunger of the solenoid valve is the normal state or the abnormal state includes:
monitoring an induced voltage generated at first and second ends of a coil of the solenoid valve based on the voltage between the drain and the source of the field effect transistor; and
determining whether the state of the plunger of the solenoid valve is the normal state or the abnormal state based on a comparison of the induced voltage, generated at the first and second ends of the coil of the solenoid valve, and one or more pre-stored normal induced voltage values.

10. The method of claim 9, wherein:
the field effect transistor is connected to the first end of the coil of the solenoid valve, and
the induced voltage of the coil is a difference of a voltage between the drain and the source of the field effect transistor and a voltage applied to the second end of the coil.

11. The method of claim 9, wherein the one or more pre-stored normal induced voltage values include a voltage value of a normal induced voltage that changes over time during a predetermined time interval.

12. The method of claim 9, wherein the determining of whether the state of the plunger of the solenoid valve is the normal state or the abnormal state includes determining that the state of the plunger of the solenoid valve is the normal state when a difference between the induced voltage, generated at the first and second ends of the coil of the solenoid valve, and the one or more pre-stored normal induced voltages is within a predetermined reference error range.

13. The method of claim 9, wherein the determining of whether the state of the plunger of the solenoid valve is the normal state or the abnormal state includes determining that the state of the plunger of the solenoid valve is the abnormal state when a difference between the induced voltage, generated at the first and second ends of the coil of the solenoid valve, and the one or more pre-stored normal induced voltages is out of a predetermined reference error range.

14. The method of claim 9, wherein the abnormal state of the plunger of the solenoid valve includes at least one of a state of an influx of foreign matter into the plunger or a state of restricted movement of the plunger.

15. A brake apparatus, comprising:
a solenoid valve including a coil and a plunger movably disposed in the coil;
a drive circuit configured to drive the solenoid valve, a memory configured to store one or more normal induced voltage values; and
a controller electrically connected to the coil of the solenoid valve,
wherein the controller is configured to:
monitor an induced voltage generated at first and second ends of the coil, and
determine whether a state of the plunger of the solenoid valve is a normal state or an abnormal state based on a comparison of the induced voltage generated at first and second ends of the coil and the one or more normal induced voltages stored in the memory, and
output information based on the determining of whether the state of the plunger of the solenoid valve is the normal state or the abnormal state.

16. The brake apparatus of claim 15, wherein:
the drive circuit includes a field effect transistor connected to the first end of the coil, and
the controller is configured to determine a difference between a voltage between a drain and a source of the field effect transistor and a voltage applied to the second end of the coil.

17. The brake apparatus of claim 16, wherein the controller is configured to identify the voltage between the drain and the source of the field effect transistor when a change in the voltage between the drain and the source of the field effect transistor, which is generated immediately after turning on or off the solenoid valve, is greater than a predetermined threshold change.

18. The brake apparatus of claim 15, wherein the stored one or more normal induced voltages include a voltage value of a normal induced voltage that changes over time during a predetermined period of time.

19. The brake apparatus of claim 15, wherein the controller is configured to:
determine that the state of the plunger of the solenoid valve is the normal state when a difference between the induced voltage, generated at first and second ends of the coil, and the one or more pre-stored normal induced voltages is within a predetermined reference error range, and
determine the state of the plunger of the solenoid valve is the abnormal state when the difference between the induced voltage, generated at first and second ends of the coil, and the one or more pre-stored normal induced voltages is within the predetermined reference error range.

20. The brake apparatus of claim 15, wherein the abnormal state of the plunger of the solenoid valve includes at least one of a state of an influx of foreign matter into the plunger or a state of restricted movement of the plunger.
